(19) United States
(12) Patent Application Publication
(10) Pub. No.: US 2014/0024464 A1
(43) Pub. Date: Jan. 23, 2014

(54) Massively Multiplayer Online Strategic Multipurpose Game

(71) Applicant: Vitaly BELAKOVSKY, Holon (IL)

(72) Inventor: Vitaly BELAKOVSKY, Holon (IL)

(21) Appl. No.: 13/555,156

(22) Filed: Jul. 22, 2012

(51) Int. Cl. G06F 17/30

(52) U.S. Cl. 463/43

(57) ABSTRACT

A computing system, logic and method for providing a gaming platform, including: (a) at least one networked server; (b) a client computer-readable instruction set downloadable by a user; and (c) at least one entity storage unit, for storing a database of game entities of the gaming platform, where the game entities are use for generating games on the gaming platform.

### FIELD AND BACKGROUND OF THE INVENTION

The present invention relates to an online multiplayer game and, more particularly, to a new type of massively multiplayer online strategic multipurpose game (MMOG SMP).

### PRIOR ART

A MUD (originally Multi-User Dungeon, with later variants Multi-User Dimension and Multi-User Domain), is a multiplayer real-time virtual world, usually text-based. MUDs combine elements of role-playing games, hack-and-slash, player-versus-player, interactive fiction, and online chat. Players can read or view descriptions of rooms, objects, other players, non-player characters, and actions performed in the virtual world. Players typically interact with each other and the world by typing commands that resemble a natural language.

A Talker is a chat system that people use to talk to each other over the Internet. Dating back to the 1980s, they were a predecessor of Instant Messaging (IM). A talker is a communication system that is a form of online virtual world in which multiple users are connected at the same time to chat in real-time. People log into talkers remotely (usually via telnet), and have a basic text interface with which to communicate with each other. The early talkers were similar to MUDs with most of the complex game machinery stripped away, leaving just the communication level commands—hence the name “talker”.

A Massively Multiplayer Online Game (also called MMO and MMOG) is a multiplayer video game which is capable of supporting hundreds or thousands of players simultaneously. By necessity, they are played on the Internet, and usually feature at least one ‘persistent world’. A persistent world means that the game continues to evolve while the player is offline and away from the game. MMOGs are, however, not necessarily games played on personal computers. Most of the newer game consoles, including the PSP™, PlayStation 3™, Xbox™ 360, Nintendo DS™ and Wii™ can access the Internet and may therefore run MMO games. Additionally, mobile devices and smartphones based on such operating systems as Android™, iOS™ and Windows Phone™ are seeing an increase in the number of MMO games available. MMOGs can enable players to cooperate and compete with each other on a large scale, and sometimes to interact meaningfully with people around the world.

Massively Multiplayer Online Role-Playing Game (MMORPG) is a genre of role-playing video games in which a very large number of players interact with one another within a virtual game world.

As in all role-playing games (RPGs), players assume the role of a character (often in a fantasy world) and take control over many of that character's actions. MMORPGs are distinguished from single-player or small multi-player RPGs by the number of players, and that the game is characterized as having a persistent world.

MMORPGs are played throughout the world. Worldwide revenues for MMORPGs exceeded half a billion dollars in 2005, and Western revenues exceeded US$1 billion in 2006. In 2008, Western consumer spending on subscription MMOGs grew to $1.4 billion. World of Warcraft™, a popular MMORPG, has more than 10 million subscribers as of November 2011.

Examples of MMORPG and Online Games

Eve Online is a video game by CCP Games. It is a player-driven, persistent-world MMORPG set in a science fiction space setting. Characters pilot customizable ships through a galaxy of over 7,500 star systems. Most star systems are connected to one or more other star systems by means of stargates. The star systems can contain moons, planets, stations, wormholes, asteroid belts and complexes.

Players of Eve Online can participate in a number of in-game professions and activities, including mining, piracy, manufacturing, trading, exploration, and combat (both player versus environment and player versus player). The character advancement system is based upon training skills in real time, even while not logged into the game. The playing environment, or universe, in Eve Online consists of more than 5000 star systems, as well as 2500 randomly accessible wormhole systems, taking place in 23341 C.E. Unlike other massively multiplayer online games, player characters in Eve Online advance continuously over time by training skills, a passive process that occurs in real world time so that the learning process continues even if the player is not logged in.

Active Worlds™ (AW) is a 3D virtual reality platform. Users assign themselves a name, log into the Active Worlds universe, and explore 3D virtual worlds and environments that other users have built. Users can chat with one another or build structures and areas from a selection of objects. AW allows users to own worlds and universes, and develop 3D content. The game browser has web browsing capabilities, voice chat, and basic instant messaging. This integrated software can allow users to connect, explore, and gain a more in depth understanding of AW. Corporate and educational clients of Active Worlds™ can make use of the interaction, communication, and media to provide functional environments suited for their objectives.

‘Building’ allows users to create their own environment. For example, a user may search an open area or request an open plot of land and then construct the walls of the building with sets of wall objects in a variety of shapes. AW is divided into “worlds”, which are contained environments for multiple users to communicate and, in some instances, build in. Worlds in AW are either owned by AW itself or individual citizens. Worlds can be purchased from the AW website. Worlds are constrained by their size, the size of the world being the amount of build-able land before you reach an invisible boundary where objects may not pass outside of.

As with worlds, users can purchase their own private “universe”, which may be a single stand-alone world, or a contained environment of multiple worlds, much like AW itself. In addition, universes are limited by their total land mass and maximum simultaneous users online at one time, which is the total of landmass that each size of the world adds up to. As the AW platform evolves, universe owners must purchase universe server upgrades directly from Active Worlds, which is 40% of the universe purchase price after the first year of owning the universe.

Second Life™ is an online virtual world developed by Linden Lab. It was launched on Jun. 23, 2003. A number of free client programs, or Viewers, enable Second Life users, called Residents, to interact with each other through avatars. Residents can explore the world (known as ‘the grid’), meet other residents, socialize, participate in individual and group activities, and create and trade virtual property and services with one another. Second Life™ is intended for people aged 16 and over, and as of 2011 has about one million active users.

Built into the software is a three-dimensional modeling tool based around simple geometric shapes that allows residents to build virtual objects. There is also a procedural scripting language, Linden Scripting Language, which can be used to add interactivity to objects. Sculpted priors (sculpties), mesh, textures for clothing or other objects, and animations and gestures can be created using external software and imported. The Second Life™ Terms of Service provide that users retain copyright for any content they create, and the server and client provide simple digital rights management functions.

The status of Second Life™ as a ‘virtual world’, a computer game, or a ‘talker’, is frequently debated. Unlike a traditional computer game, Second Life™ does not have a designated objective, nor traditional game play mechanics or rules. It can also be debated that Second Life™ is a multi-user virtual world, because the virtual world is centered around interaction between multiple users. As it does not have any stipulated goals, it is irrelevant to talk about winning or losing in relation to Second Life™. Likewise, unlike a traditional talker, Second Life™ contains an extensive world that can be explored and interacted with, and it can be used purely as a creative tool set if the user so chooses.

U.S. Pat. No. 6,219,045 to Leahy et al., teaches a highly scalable architecture for a three-dimensional graphical, multi-user, interactive virtual world system. A plurality of users can interact in the three-dimensional, computer-generated graphical space where each user executes a client process to view a virtual world from the perspective of that user. The virtual world shows avatars representing the other users who are neighbors of the user viewing the virtual world.

U.S. Pat. Nos. 7,493,558 and 7,181,690 also to Leahy et al., teach systems and methods for enabling users to interact in a virtual space.

U.S. Pat. No. 5,736,982 to Suzuki et al., teaches a virtual space apparatus with avatars and speech. Each of the aforementioned patents is incorporated by reference for all purposes as if fully set forth herein.

While the MMOG industry has been developing for the past 15 or so years, and currently hosts a global market representing billions of dollars, no MMOG has harnessed the energy of its global participants for the benefit of our global community.

Many science fiction movies, television programs and books have posited numerous current and futuristic problems in story lines. Franchises such as Star is Trek™ and Stargate™ television programs and movies provide a plethora of scenarios and hypothetical situations. Unfortunately, these entertainment mediums are unidirectional in nature, created by the writers, directors and producers as a ‘sealed package’ for the viewers. The ‘sealed package’ includes a solution to the problem or problems presented during the plot of the story. The viewer/reader is not provided with an interactive environment where it is possible to provide an alternative solution to the problem or grapple with the problem in a collaborative forum.

It would be highly advantageous to have an online multiplayer game having a variety of goals, uniting different games on various topics. It would be further advantageous to have a multiplayer game that is built based on a modular system where a user selects the modules for building a game according to personal preferences and in accordance with their personality type.

### SUMMARY OF THE INVENTION

The platform of the immediate invention affords scientists, technologists, psychologists, sociologists, philosophers and young people the opportunity to address problems facing society in a corroborative and enjoyable setting. By providing an intelligent gaming platform on which global learning and research communities can develop, the immediate gaming platform further provides a profitable global market place in which revenue is generated by participates' learning about, researching into and innovating for the benefit of the global community.

According to the present invention there is provided a computerized system including: a processor; at least one database of game entities; and a computer-readable non-transient memory in communication with the processor, the memory storing is instructions for providing a gaming platform, the instructions including: (a) program code for a server-side system including: (i) a game generator program for generating games using at least one of the game entities, (b) program code for a downloadable client side system including: (i) a game selector program for selecting at least one game entity for game generation by the game generator program on the server-side system.

According to further features in preferred embodiments of the invention described below the server side system further includes: (ii) a Scenario Generator program for generating scenarios for a generated game.

According to still further features the Scenario Generator generates scenarios selected from the group comprising: user-defined scenarios, random scenarios, semi-random scenarios and pseudo-random scenarios.

According to still further features the downloadable client side system further includes: (ii) a Scenario Editor program, for providing editing instructions to the Scenario Generator for editing the scenarios, and where the editing instructions include instructions to effect functions selected from the group including: creating the user-defined scenario for a generated game, deleting a scenario from a generated game and altering a scenario.

According to still further features the program code for the server-side system further includes: (ii) a Personality Generator program, for defining parameters of a generated game in accordance with a set of predefined Personality Type rules, wherein the predefined Personality Type rules are dictated by a personality classification system.

According to still further features the game entities are selected from the group comprising: predefined game entities, game entities imported from an external source and user-defined game entities. According to still further features each of the game entities includes: (i) a structure, defined by parameters of the structure; (ii) at least one sub-structure, associated with the structure; and (iii) a plurality of elements, populating the at least one sub-structure.

According to still further features the program code for the downloadable client side system further includes: (ii) a Game Entity Editor program, for editing the game entities, wherein editing of the game entities includes effecting functions selected from the group including: altering parameters of a gaming entity and creating a new gaming entity.

According to another embodiment there is provided a computing system for a gaining platform, including: (a) at least one networked server; (b) a client computer-readable instruction set, associate with the at least one networked server and downloadable by a user, the instruction set for interacting with the at least one network server; and (c) at least one entity storage unit, associated with the at least one networked server, for storing a database of game entities of the gaming platform, the game entities for generating games on the gaming platform.

According to another embodiment there is provided a method for facilitating crowd sourcing using a gaming platform, the method including the steps: (a) providing a server, including: (i) a database of game entities, (ii) a Scenario Generator module for generating scenarios using game entities selected from the database, and (iii) downloadable Scenario Editor module, for electively selecting at least one game entity from the database and instructing the scenario generator to generate a scenario using the at least one selected game entity; (b) receiving scenario generating instructions from an instance of the Scenario Editor module that has been downloaded to a client, for the Scenario Generator module to generate a scenario.

According to still further features the method further includes the steps of: (c) generating a scenario according to the received scenario generating instructions; (d) publishing the generated scenario to a plurality of Players over a Data Network; (e) receiving interactions from the Players over the Data Network; and (f) sending server responses, responsive to the Player interactions, over the Data Network.

According to still further features the method further including the step of: (g) providing observation tools, for observing the interaction of the players with the generated scenario.

According to still further features the observing includes activities selected from the group including: recording player interaction sequences in a recordation archive, recording player solutions to the generated scenarios in the recordation archive, analyzing player interaction sequences, analyzing player solutions to the generated scenarios.

According to still further features the Data Network is a network selected from the group including: an internetwork of networks, an intranet.

According to still further features the method further includes the step of: (h) providing a publication tool for publishing a portion of the observations.

The present invention discloses an innovative massively multiplayer online strategy multiple purposes game. Each game can be constructed/built based on a ‘Basic Module’ or more than one such basic module. In the currently depicted exemplary embodiment of the game matrix, a user can choose from 20 basic modules or ‘games’. When more than one basic module is selected, the other modules function as ‘secondary’ or ‘additional’ modules. Each module is has a basic structure or framework otherwise known as the Basic Structure of Module (BSoM). Furthermore, auxiliary structures or substructures support and/or comprise the basic structures. These are known as the Substructures of Modules (SoM). There exist further, sub-substructures (SSoM) for each SoM. ‘Elements’ make up the all of the aforementioned frameworks.

A game in the MMOG SMP is made up or ‘constructed’ from BSoMs, SoMs, SSoMs and their respective elements. The user selects a base module or modules (games) and selects the relevant structures and elements for the module or modules. Since each game is made up from a different selection of modules and/or structures of those modules, each game is unique to the user. Once a game has been created, other players/users can join an existing game, so that while some users are also creators (see ‘Game Master’ below) other users may simply be players of the created games. The potential number of players is unlimited. The number of potential variations of the games is limited to the number of structures and elements, both of which can be expanded upon and added to at any time.

In the game, the element ‘Time’ has a unique dynamic, not found in other games. Unlike other games, in the current innovation, the element of time can be uniquely manipulated within the parameters of the game. Time can be treated in a linear manner, or in a non-linear manner, where the user can choose to be in the past, future or present. The user can speed up time or jump to a point in the future or past.

A further unique element of the game is that the user constructs the ‘universe’ in which the game takes place according to a personal selection, such that the physical properties of the universe can be different to the physical properties of the real universe, so that the physical properties reflect the user's personal selection. Preferably, the selection should be reflective of the personality type of the user. In some embodiments of the current invention, the personality type is defined according to the Myers-Briggs Type Indicator (MBTI) assessment which is based on the theories proposed by Carl Gustav Jung and first published in his 1921 book Psychological Types (English edition, 1923). The 16 personality types are generally defined according to traits selected from four dichotomies. The four dichotomies are Extraversion (E) vs. Introversion (I); Sensing (S) vs. Intuition (N); Thinking (T) vs. Feeling (F); and Judgment (J) vs. Perception (P). For example, one of the 16 personality types is the ESTJ (extraversion (E), sensing (S), thinking (T), judgment (J)) type personality, where the individual has an extroverted attitude; functions by sensing and thinking and prefers to use their judging function when relating to the outside world.

### BRIEF DESCRIPTION OF THE DRAWINGS

Various embodiments are herein described, by way of example only, with reference to the accompanying drawings, wherein:

FIG. 1 is an exemplary table of modules for constructing a game according to an embodiment of the current invention;

FIG. 2 is an exemplary table of the Basic Structures of Modules (BSoM) listed in the table of FIG. 1;

FIG. 3 is a table including a number of exemplary substructures for a small selection of modules from the table of FIG. 1 and FIG. 2;

FIG. 4 is a basic depiction of the innovative system;

FIG. 5 is a schematic block-drawing of a preferred embodiment of the hardware/software architecture of the innovative gaining platform;

FIGS. 6A and 6B are schematic block drawings of preferred embodiments of the architecture of the innovative gaming platform;

FIG. 7 is an exemplary high-level deployment diagram for the innovative gaming platform.

### DESCRIPTION OF THE PREFERRED EMBODIMENTS

The principles and operation of an online multiplayer game according to the present invention may be better understood with reference to the drawings and the accompanying description. The Game is called World of Creation (WoC)

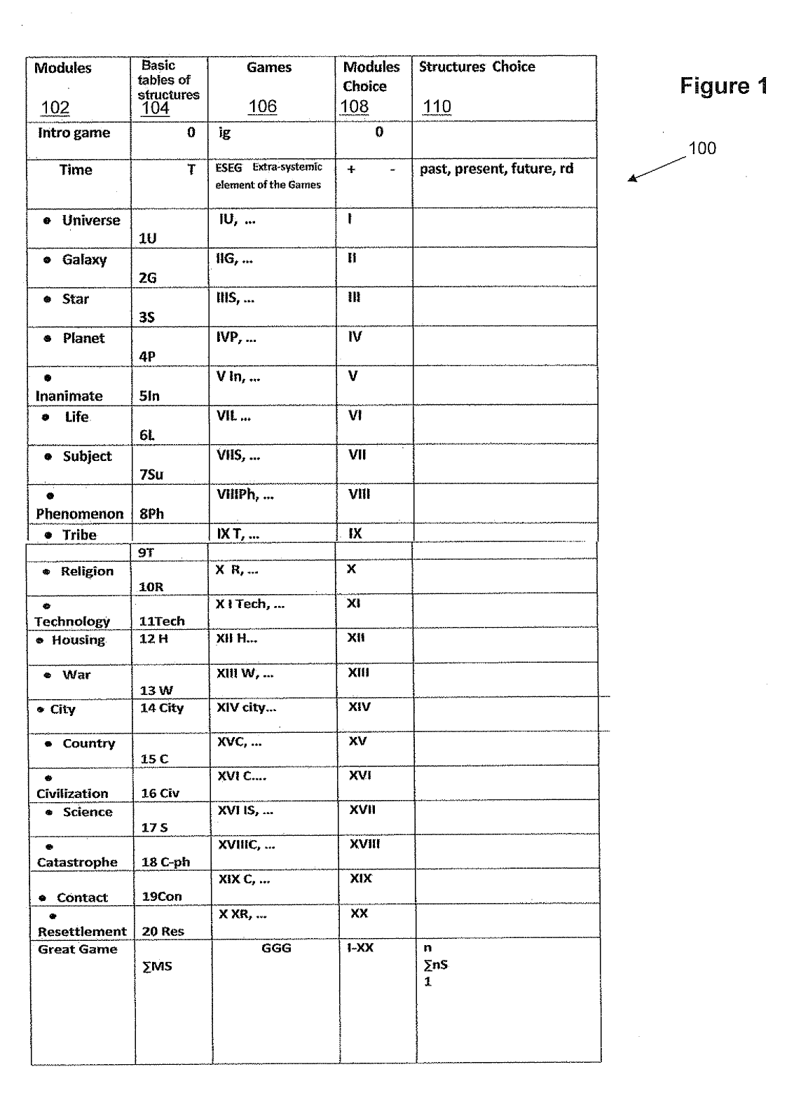

The game includes multiple phases and modules. Each game is ‘constructed’ from modules. Referring now to the drawings, FIG. 1 illustrates a non-limiting, exemplary table or chart for constructing a game according to an embodiment of the current invention. In particular, a table 100 represents a selection rubric or summary chart from which a game can be created or constructed.

Chart 100 is composed of five vertical columns and 23 lines. There are five columns: 1) Modules 102; 2) The basic tables of the structures 104; 3) Games 106; 4) Selection of games/modules/themes 108; and 5) Selection of the structures 110. There are 20 modules 102, listed in the Modules column 102. Each of these modules can be a single game in their own right. In other instances, each module is a theme within a game, such that one main module is selected and subsequent modules which are selected are considered secondary or ‘theme’ modules, all of which are tied to the same story line.

Modules

There are exemplarily provided the following modules, in chart 100 and which compose the contents of World of Creation:

Module Universe
Module Galaxy
Module Star
Module Planet
Module Inanimate
Module Life
Module Subject (in other games at this location the Characters are placed)
Module Phenomenon
Module Tribe
Module Religion
Module Technology
Module Housing
Module War
Module City
Module Country
Module Civilization
Module Science
Module Catastrophe
Module Contact
Module Resettlement

One main module can be selected and thereafter any other module selected from the list becomes a secondary module. As mentioned previously and further detailed below, numerous sub-structures, sub-sub-structures and elements exist from which relevant objects/elements can be selected for each module.

Basic Structure of Modules, Sub-Structures of Modules and Elements

BSoM

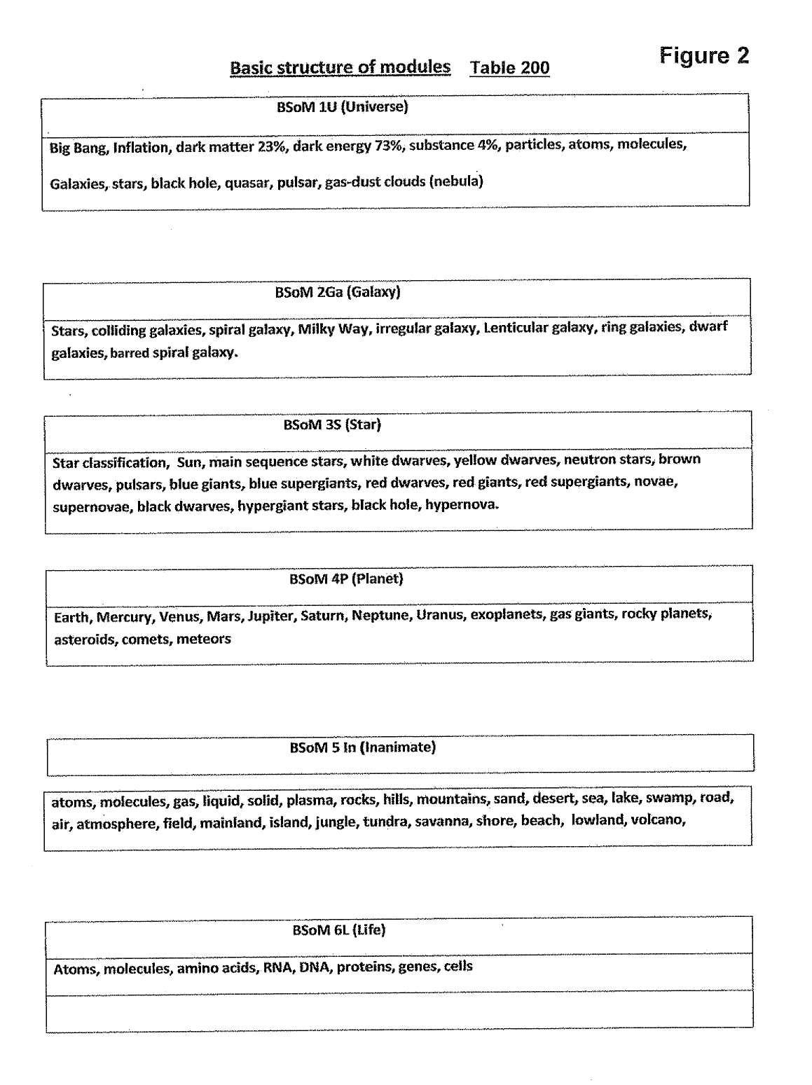

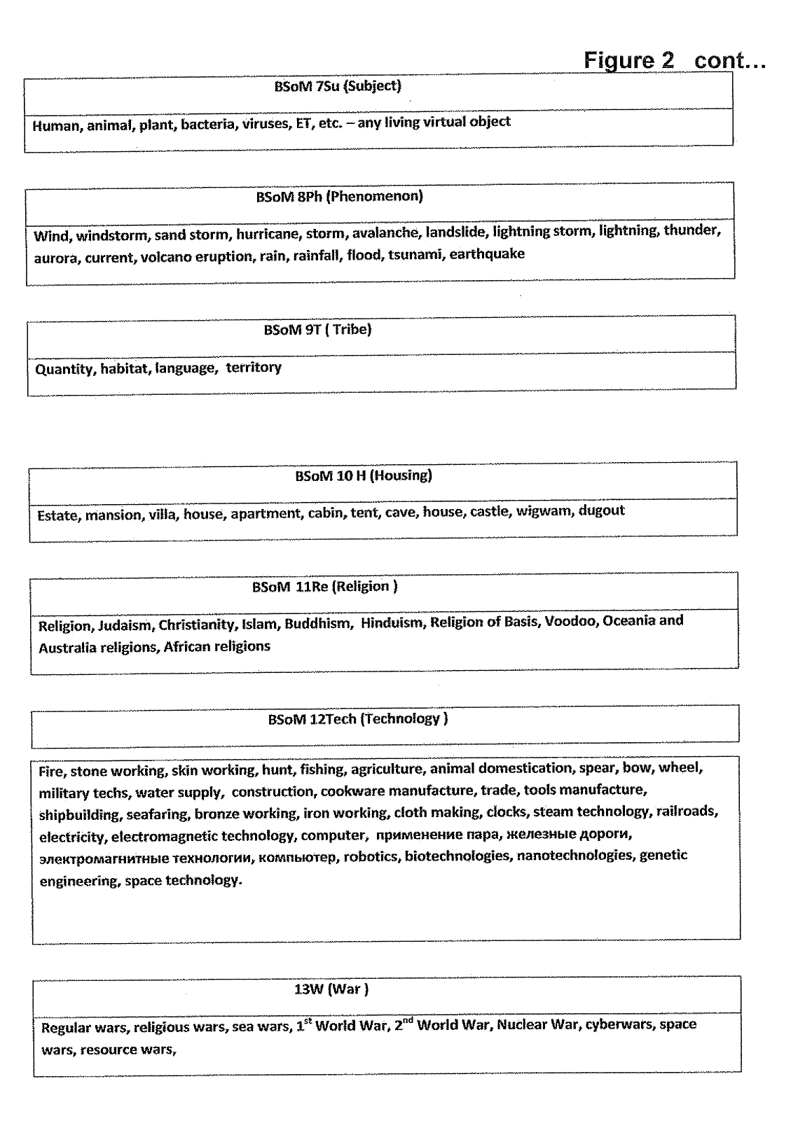

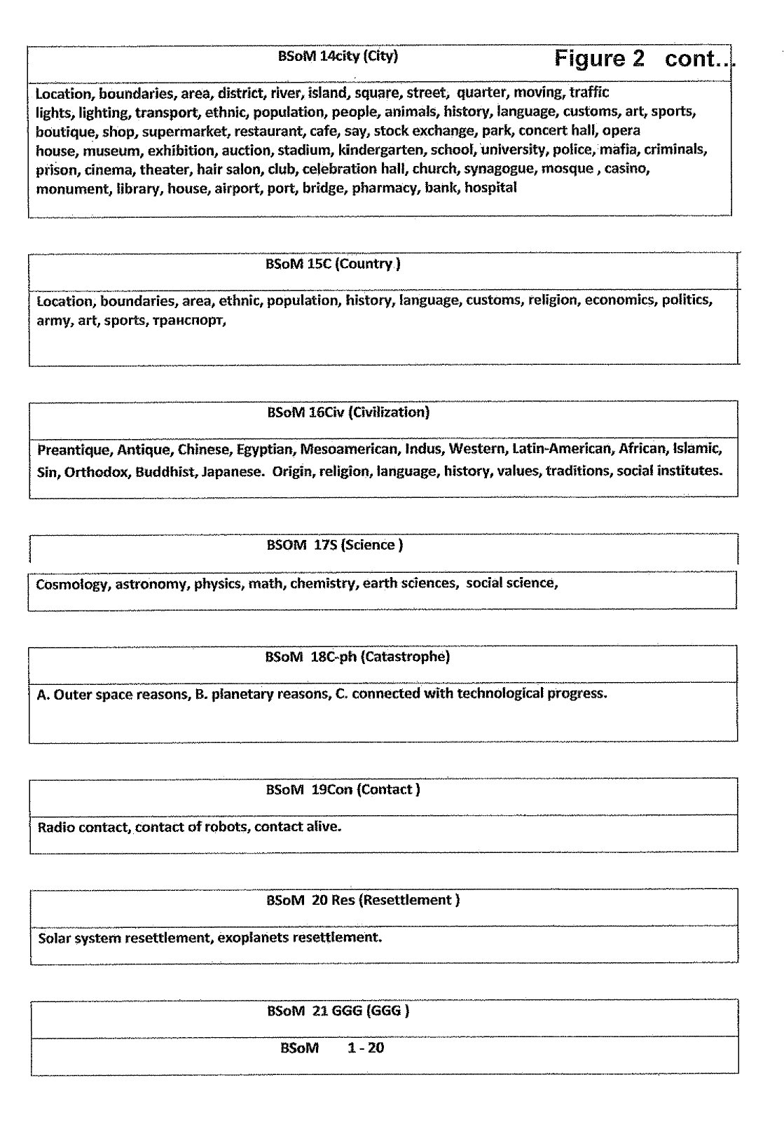

Referring back to the columns, the second column includes the ‘Basic Tables of Structures’ 104. Column 104 is used to cross reference with a second table 200, depicted in FIG. 2. FIG. 2 is an exemplary table 200 of the Basic Structures of Modules (BSoM) listed in the second column of the table of FIG. 1. Table 200 is a table of the Basic Structures of Modules (BSoM). Table 200 includes basic details for each given Module 102. Each Module 102 has a unique structure, called Basic Structure of Modules (or BSoM). There are a total of twenty such BSoMs, one for each Module. The details for each structure are based on the current knowledge of the universe around us. Alternatively, the structure of the modules may be based on hypothesized parameters of other universes, potentially in accordance with the multiple-universes or ‘multiverse’ hypothesis or other hypotheses in the same vein.

### SSoM & Elements

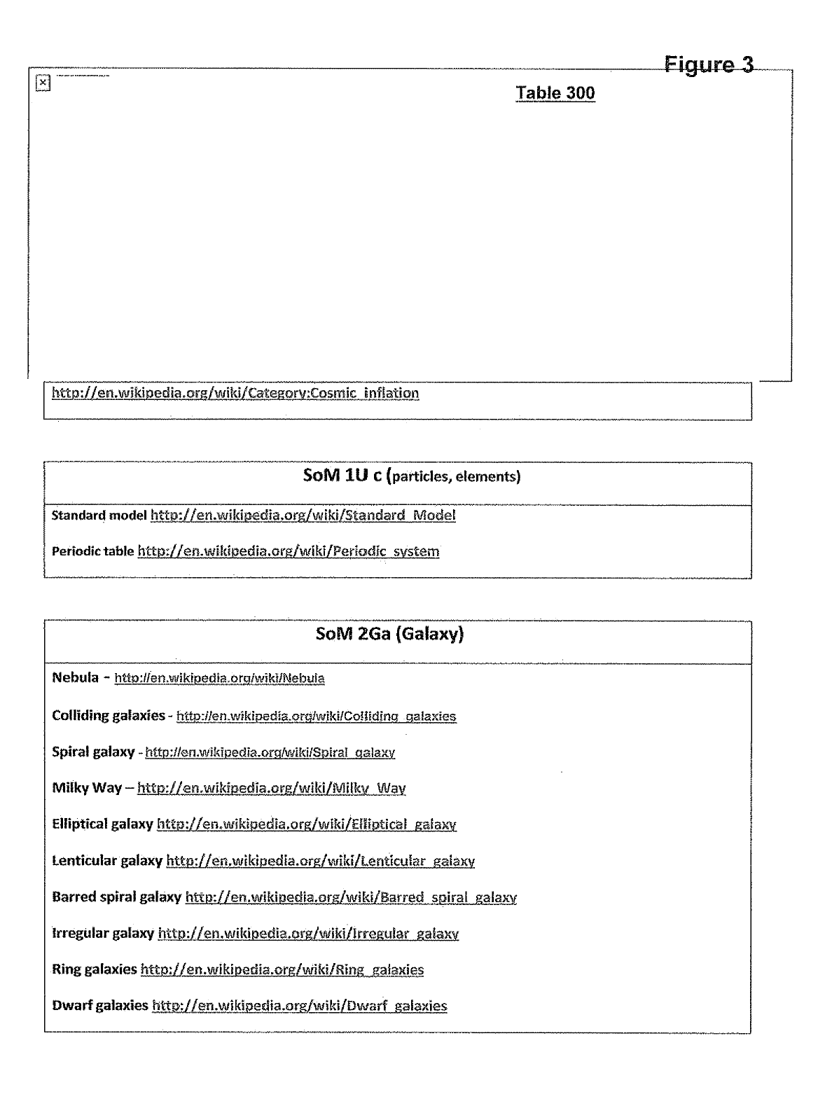

Each BSoM includes substructures called Sub-Structures of Modules (SSoM). FIG. 3 depicts a table 300 including a number of exemplary SSoMs for a small selection of BSoMs found in table 200 of FIG. 2. Referring to FIG. 3, a third table 300 is depicted including a number of exemplary substructures SSoMs for a small selection of BSoMs of Modules selected from table 200. Exemplarily, each Sub-Structure is composed of Elements. Some SSoMs can have 3-4 Elements while others can have 65 or more—all depending on the nature of the Structure. Usually, the average game has around 350,000 objects or elements which are active. In some embodiments of the platform, the Elements may not conform to the laws of physics that govern the real universe and a fictitious universe with fictitious elements may be created.

In some embodiments of the game, a player can consistently return to the twenty main subjects/modules (going through the above scenario), but each time can select a different structure or structure from the main subjects/modules. Following this selection process a player can create a great number of games. Large scale games are intended for advanced level players in the game.

The Game

For each game of World of Creation (sometimes referred to as GGG) there exist three sub-versions of the games: (1) Introductory version; (2) Overall game—general; and (3) Overall game—study version.

(1) Introductory version: a trial version, free of charge—includes a game according to a certain scenario determined in advance, which continues for a certain, short period of time, like a month. The player can change the scenario or the duration of the game. This game is free of charge and is intended for players at a basic level of game. This version is found in table 100 in the first row of the table under the title: Introduction Game (IG).

(2) Overall game—general: is composed consistently of 20 central games which create (the modules or main subjects discussed above) and join the 20 main subjects with one scenario.

(3) Overall game—study version: the game is based on the full selection of the player with a high command of the game. In this game there is the possibility to select, at the outset, the main subjects themselves (modules/games), the structures of the main subjects/modules and their sub-structures. High level players, in this version, can also study, and participate in seeking solutions to various problems (this will be discussed at length below).

Personality Types

A relatively new subject in all the known games is the subject of the methods used to characterize the personality of the individual. At present in the science of personality types (studied in Sociology and in Psychology) it is customary to analyze habitually the characteristics of the personality, which in differing degrees of success describe the type of personality of the individual. According to the “Indicator of types by Myers-Briggs”, which is used in the science of the types of personality, there are 16 kinds of personality, which are composed of 4 pairs of alternative preferences (discussed above):

| | |
|---|---|
| Extrovert (E) | Introvert (I) |
| Sensual (S) | Intuitive (N) |
| Thinking (T) | Emotional (F) |
| Decisive (J) | Receptive (P) |

In the study version (for players at a high level of skill), there is provided a program, for identifying the personality type of a player. Potentially the system can analyze a set of answers to predefined questions in order to determine the personality type of the player. In one embodiment, the program selects a suitable scenario for the identified personality type of the player which takes into account the subjects most suitable for this type of personality.

Furthermore, innovatively, with the option of changing parameters of the modules, players (usually high level players) can construct a game (e.g. a ‘universe’) which is favorable to a particular personality trait. Therefore, for each of the aforementioned twenty modules, there are, theoretically, at least 16 variations of the module (according to the 16 personality types of the Myers-Briggs system), resulting in (16×20=) 320 possible modules.

Time—In the Game

In the second row of table 100 there is provided a resource, ‘Time’, which, is an Extra-Systemic Element of the Games (ESEG). ESEG Time is a component outside of the system of the Games. This component includes the structure of the past, present, future, real time and different historical dates; the player can activate the parts of this structure as he wishes. Exemplarily, this resource is marked in the chart with a plus or minus. In other words, the player can select whether to use this element in a game or not. If the user selects not to use the ESEG then the game will be outside of the time-factor, in other words, naturally time passes for the player, but the game itself is outside the natural time-factor. WoC is different from other games in that while other games function either within the time-factor (such as MMORPGs) and other function outside of the natural time-factor, here the user can electively control whether the game exists within the time-factor or not.

Location

The first component of the game we discuss is Location. Among the main modules 102 and the secondary modules (i.e. modules 102 selected to support or provide a theme or subject to enhance the main module/game) there are modules which define cosmological, geographic, and historical location of the objects in the game. By selecting such modules, a user defines the location of the player within a universe.

Goals

The next component of the game we discuss is the Goals component. The goals of the game differ according to each version of the game the user is playing.

For example, for IG (1), the goal of the game to reach the desired results defined in advance, according to a scenario, within a certain period of time (real time). For the general version of the overall game (2) there is a certain personal and consistent scenario, which joins the 20 subjects/modules (or part thereof) in a consistent way. Although, owing to the fact that each of the 20 main objects/modules has its own personal structure, the player can choose to deviate from the path defined by the consistent scenario and can select secondary targets or goals.

Exemplarily, for the study version of the overall game (3), the goals may be variable/dynamic since the change depends upon the selection of main subjects/modules by the player, the structures of the main subjects/modules and elements contained in structures and sub-structures. The final goal in this version is created after selection of the above parts as a sum-total of the goals of these parts.

In general, all the objects in the game are related to each other in a “plural to plural” relationship—meaning, that each change during the game with any object is an occurrence in the system of the game, and each object can react to occurrences.

Education and Research

In general, the Game can be regarded as an educational tool. Each scenario endeavors to provide accurate objects such as a correct gravity-to-size ratio of a astronomic body (moon, planet etc.). By providing scientifically correct information, a user/player can learn a great deal of information (whether scientific, political, sociological etc). On a basic level, education is facilitated within the framework of the game (for instance, using—Wikipedia), but it is possible to complete an educational process via existing sites of training/education which exist on the internet, such as, for instance, an online university. Work with external providers is carried out on the basis of agreements.

Furthermore, the innovative game can potentially provide ‘open’ problems or theoretical problems from the scientific realm or societal realm etc. to the user, so that the users/players work towards providing solutions for these-real-problems.

Scientific research can also be carried out by researchers in cooperation with players. Research-fellows create three information databases to be used as an aid to the game and the research. The first information database is used to provide players with information about the objects presented in the given scenarios of the Game. The second database is for the use of the researchers themselves, as a resource relating to the methods and/or systems which are being researched. Players have no access to this database.

Research in this case is effected as follows: initially the first database is provided to the users. Once ‘in play’, a third data-base is created with “diffuse” research carried out by the players, the results of which are later added to the database by the researchers.

Payment

One envisioned payment scheme is to charge players for the time the player is playing the game online. In one exemplary embodiment, a player purchases a certain number of hours, and from the moment the player enters the system of the game a clock is activated to calculate the duration of the game. When arriving at a certain minimum amount of remaining time, the player is advised of the mount of time left and asked whether interested in purchasing additional time. All these actions are carried out by a computer-program sub-module.

The aforementioned payment scheme is an option scheme for the type (2) version of the game. By contrast, when engaging in a type (3) version of the game the method becomes more complex. The game itself is more evolved and also includes an educational component to the game as well as a solution seeking component. Therefore, an exemplary payment scheme for the type (3) version of the game consists of three parts:

a. The first part is payment for the game itself and is effected according to the exemplary guidelines for the type (2) version.

b. The second part is payment for education/training and depends upon payment for education/training through a particular online university or equivalent institution.

c. Participation in the solutions to problems and research for the players is free of charge (potentially, doctorate research/solution seeking may be sponsored by the relevant institution which pays a portion of the stipend to the System).

Solutions

Solutions, or the process to find a solution or even the failure to successfully find a solution or to find a solution that was successful, are all productive results and may serve as the basis for research conducted by research centers, think tanks, etc. that are charged with planning to solve future existential (or even non-existential, but nonetheless important) problems facing civilization. In recent times the concepts of ‘crowd sourcing’, ‘collective brainpower’, ‘citizen science’ etc. reinforce the notion that the general populace can help solve problem, even complex scientific ones. Potentially, the same concept can be applied to social, sociological, environmental and even existential problems, as well as many other problems that do not fit into the aforementioned categories.

Uniquely, in one embodiment, the current gaming platform does not pose a problem to the masses in order to find a solution. Rather, the platform generates (randomly, or semi-randomly) a problem based on the parameters of the game (and all the objects in the game) that were defined by a creator-user. Certain problems may be similar to real-world problems is as much as a viral pandemic is a viral, pandemic, but the specific parameters or variables for each scenario make each problem unique. Furthermore, a solution for one problem may only become obvious in one scenario, whereas the same solution would be dismissed out of hand in a second scenario, even in cases where both scenarios share a similar problem (e.g. a viral pandemic). See below the section on Authoring for a further embodiment of the invention whereby a scenario is specifically generated (e.g. for the purpose of studying a specific situation).

Recently, Firas Khatib, a researcher from the University of Washington, Seattle, published (together with his team) a research paper in Nature Structural & Molecular Biology 18, 1175-1177 (2011) (received 27 May 2011, accepted 8 Jul. 2011, and published online 18 Sep. 2011). In the paper, the authors report that they “challenged players of the protein folding game Foldit to produce accurate models of the protein. Remarkably, Foldit players were able to generate models of sufficient quality for successful molecular replacement and subsequent structure determination. The refined structure provides new insights for the design of antiretroviral drugs”. Numerous online players of the game Foldit™ were able to solve a problem which researchers had not been able to solve to date.

The current gaming platform, as explained previously, differs significantly from games devised by an interested party which is to be solved by a second party. Significantly, games devised for finding a solution to a specific problem are by definition limited to known or hypothesized problems. On the other hand, seemingly impossible problems (e.g. problems which go against the known laws of physics in the real universe) can both be posed (i.e. generated by the gaming platform) and potentially solved. Seeing as the innovative gaming platform allows a user to create and define a unique universe, potentially having different laws of physics etc. governing the universe, even impossible problems can be posed and solved. At least for the aforementioned reasons, the currently described platform is innovative over the known prior art.

In a preferred embodiment, the innovative gaming platform includes a database for recording all of the problems and solutions (whether successful or not) that the game and players generate. Furthermore, the discussions and collaborations are also recorded. One exemplary use for the recorded data may be an annual survey of the gaming platform, which includes analysis of online games that pose the most important problems facing society and the solutions that where found. Exemplarily, recommendations can be made to governing bodies based on the analysis. A second exemplary use of the recorded data is for the data to be fed back into the gaming platform, thereby creating and additional knowledge base, beyond basic knowledge base upon which the games are initially created.

Interaction Among the Players

The interaction among the players is carried out in two levels, which complement each other. The first level is the interaction among the players in the game, and the second level is the interaction among the groups of players according to the number of players in every group.

The interaction among the players in the game is effected only according to a system of hierarchy. Exemplarily:

First stratum: Game-Master of the created and present game and all the objects activated therein—whoever defines the general parameters of the game, defines targets and conditions for the realization thereof. Further exemplarily, the Game Master can change the goals and parameters at any time and can also get involved in the actions of each player. The Game master can appoint any player as Game Master and pass over the job in part or in full to that player.

Second stratum: Includes players who joined the created game early on and currently control the various objects. The third stratum and further strata (depending on the number of players in a given game) participate in the administration of structures, sub-structure elements and so on.

Important: The players of one stratum cannot influence the main subjects/modules and structures of the other players in the same stratum, but they can influence the players at a lower stratum in the framework of their structure—changing, adding or removing parameters and the like.

| | Minimal | Maximal | | | |
|---|---|---|---|---|---|
| | number of | number of | The name of | | |
| | players in | players in | “the group of | | |
| # stratum | stratum | stratum | players” | Marking | Leading the group |
| 1 | 1+ | 9 | Home | AH | 1 and more |
| 2 | 10+ | 99 | Street | BS | 3 and more |
| 3 | 100+ | 999 | Block | CB | 4 and more + leader |
| 4 | 1000+ | 9999 | Area | DA | 5 and more + leader |
| 5 | 10,000+ | 99,999 | Town | ET | 6 and more + leader |
| 6 | 100,000+ | 999,999 | County | FC | Parliament 19 + President |
| 7 | 1,000,000+ | 9,999,999 | Civilization | GC | A committee of countries + |
| | | | | | 9 Presidents + leader |
| 8 | 10,000,000+ | 99,999,999 | Planet | HP | A Committee of |
| | | | | | civilizations + 99 leaders |

In an exemplary embodiment of the game, leaders can be elected using a computer program sub-module, based on the 16 typical character types mentioned previously. The only exception is the Game-Master. Game-Master position is not up for election. Starting from the second stratum it is possible to elect a new leader so anything.

Example of WoC

Referring back to FIG. 1, the third column of table 100 is a Games 106 column. Using the module identifiers, a user completes the first phase of the gaming experience by compiling a list of the structures, selected from the list in the first column, that the user wishes to include in his personal game, thereby ‘constructing’ the game. For example, a user selects a ‘Planet’ (IVP) as the basic module and adds two additional modules from the same column, e.g. ‘Life’ and ‘War’. Furthermore, the user decides to activate the resource ‘Time’. In this manner the user has created a unique game constructed from three modules and one resource. At this point the platform—or more exactly, computer executable software on a server or group of interconnected servers containing instructions for the fabrication of scenarios based on selected modules—creates a scenario for the unique game compiled by the user.

Exemplarily, the resource ‘Time’ (ESEG) can include four elements: past, present, future and a real-time. When the user activates this resource, the user can control the modules using the Time resource: to go back to the past, exist in the present, jump to the future or stop at some significant time. Therefore, in the exemplary game, the scenario may dictate the development of the Planet, in the past, present and future, if these elements have been selected for the game. The same process can be repeated for the other modules of War and Life, resulting in a truly unique game. To further ‘tweak’ the game, the scenario generated can take into account the psychological profile of the user (e.g. using the MBTI classification discussed above). Using Table 100 the user enters the selected modules (and resource) in Games column 106 next to the base module. In the above example, the basic module is Planet (IVP) and the additional modules are Life (VIL), War (XIIIW) and Time (T), so that the unique game identifier (UGI) will be: IVP VIL XIIIW T. Every Basic Structure of a Module (BSoM) includes various Substructures Of Modules (SSOMs) having anywhere between 1 and 50 elements, as mentioned previously. For example, SSOM 9 may include the following 6 elements:

Tribe http://en.wikipedia.org/wiki/Tribe
Quantity http://en.wikipedia.org/wiki/Quantity
Habitat http://en.wikipedia.org/wiki/Habitat
Language http://en.wikipedia.org/wiki/Language
Dialect http://en.wikipedia.org/wiki/Dialect
Territory http://en.wikipedia.org/wiki/Territory_(country_subdivision)
where each element has a hypertext link to a knowledge database (here Wikipedia), so that the user receives an initial education regarding the selected phenomenon or elements. The element itself is a data structure that includes computer-readable features and parameters found in the referenced knowledge database. Selecting one or more elements, in a Structures Choice column 110 creates sub-sub-structure of highly personalized game. The process of selecting the basic structures, the substructures and the specific elements offers an extremely wide range of possible and even impossible games.

In the current embodiment of the invention, once the initial phase (of creating the universe in which the game is to take place) is completed, the next step/phase is to find a planetary system of the selected galaxies, which will create a new environment for the emergence of life. Preferably, a user must meet the knowledge requirements for completing the first and second phases including a basic (or even slightly in-depth) understanding of cosmology, astronomy, physics and astrobiological issues. Further preferably the user must conduct research in order to understand some of the problems that are present in creating and sustaining multiple life-supporting environments in the real universe.

In a third envisioned stage, the most appropriate planet suitable for intelligent life is selected, based on the parameters defined for the given planet.

In a fourth envisioned stage, (which is potentially the most time-consuming stage), the creation of life is detailed, as a result of the development of various natural processes.

In a fifth envisioned stage, creation and development of a civilization on selected planet is described.

The sixth envisioned stage may describe the economic, technological, social and environmental conditions existing in the populated countries.

The seventh envisioned stage may describe the formation of international relations and relations between civilizations or emerging nations. Relationships can be peaceful, warlike or a blend of both. In some embodiments, the method chosen for the design and development of a civilization may offer additional incentives for the development of a civilization in a successful manner.

In an eighth envisioned stage of the game, players are invited to find solutions to global issues that may shape the future of the civilization. Problems of this sort may be generated randomly. Alternatively or additionally, the problems may be generated by the platform based on the likelihood of such problems occurring in the real world. For example, one potential problem may be impending disaster leading to the destruction of the civilization. Examples of such a disaster may for example, include:

1) External space reasons, such as: a. collision with an asteroid or comet; b. a close explosion of Super Nova Star; c. destruction, damage or a sudden outbreak of a native star (or stars); d. gamma radiation outbreak.

2) Planetary reasons, such as: a. cataclysmic natural disasters; b. environmental disasters; c. viral pandemic; d. world wars;

3) Several reasons related to technological progress, such as: a. Biotechnology; b. Nanotechnology; c. Robot technology.

In an envisioned ninth stage, depending on the nature of the incident which occurred in the eighth stage (which may lead to the destruction of all civilization, for example), players analyze the situation and collaborate on finding a solution and/or making a collective decision to save the civilization.

In some embodiments, a game can be completed at any stage, if, for example, the players do not find a solution. For example, if a viral pandemic erupts before the civilization can somehow cope with the situation, the civilization will be destroyed. When a game has ended, players have the opportunity to re-enter the game by selecting a different problem, and/or plot, and start a new game at any of the aforementioned stages. In some embodiments, each player receives a certain amount of time to solve a specific problem. For example, it is likely that a viral pandemic will destroy civilization within a given time limit, which would lead to the cessation of the game. On the other hand, if the players can find a solution, then the game continues.

Crystal Ball

In light of the fact that WoC is very large and complex game, and in order to enter the gaming market, there is a need for a smaller version of the Game which is shorter and simpler while still reflecting the Game (WoC). The mini-Game is named “Crystal Ball”. All of the following exemplary stages of Crystal Ball (CB) are linked by a common a story line that allows a user to create a compact but capacious and interesting game.

### Example

1. Exemplarily, in an initial stage each group of ten individuals (who wish to play a game together) are tasked with each creating a universe in CB, and populating the universe in accordance with the criteria of the appearance of life as defined for each of the universes. The users can create a universe by selecting objects from an existing database, which has ready sets of physical world objects.

Then, out of every ten created universes, one universe is chosen (up to a maximum of five universes), which will be used later in the game, and will serve as the basis for the construction of all phases of the game. The five selected universes should be similar to the real universe, at least with regard to the physical characteristics of the universes. The player who creates the most correct universe, will subsequently be appointed Game Master.

And the 10 players who have successfully passed the selection stage of creating a universe, but have not created the universe similar to ours, will be candidates for the position of leaders in the selected game and in the future will be invited to become leaders of various groups of players.

2. The next steps include the selection of galaxies, then stars, which have suitable parameters for the planet to create a livable environment. Alternatively, life on a given planet may have originated elsewhere (e.g. transplanted from another planet) but continues to development further on the given planet.

At this stage, the data/knowledge base can again be accessed, allowing player to obtain information regarding the creation of life. Potentially, a dedicated program module is utilized to this end. At the same time, and in order to complete the current goal, players need to learn the basics of genetics and biology, and enjoy the advice of experts and scientists involved in the game of life, to pass the primal stages of the creation of bacteria before intelligent life, then the first civilization.

3. The next step describes the economic, technological, social and environmental conditions in the countries created by civilization. This phase can also describe the emergence of international relations and relations between countries that have emerged. Relationships can be peaceful, warlike, or mixed. For the selected CB warlike attitude, for example, all possible war types can immerge (e.g. cyber war, war over resources etc.).

After this phase, players analyze the situation and take a collective decision in order for their civilization or country to survive or triumph. The decisions taken are reviewed by experts/professionals and this analysis will be included in a closed database/knowledge not available to players.

Optionally, players who arrive at successful non-trivial solutions, which are subject to approval, may receive a prize in WoC and/or a small monetary reward. Once predefined goals have been reached the game terminates. Optionally, a portion of the player may continue the game which offers a number of further stages.

4. Advanced, successful players may be invited to participate in addressing global challenges that may shape the future of civilization. These issues can be selected randomly by a special program module which further assists players in implementing the solutions conceived.

Exemplary disasters that could lead to the destruction of civilization, for example, include:

1) The External Space Reasons:

The fall of an asteroid or comet

Supernova Explosion

Destruction, damage or a sudden outbreak of a native star (or stars)

The flash of gamma radiation

2) Planetary Reasons:

Disasters

Environmental disasters

Pandemics

World Wars

3) Reasons Related to Technical Progress:

Biotechnology

Nanotechnology

Robotic technology

5. When facing an impending disaster, which may lead to the destruction of all civilization, players analyze the situation and formulate individual and/or collective solutions to save the planet/civilization.

The solutions (and possibly simulated results of implementing the solutions) are entered into another database/knowledge base created specifically for this purpose, and analyzed by scientists and specialists, and later published in two versions: one for the general public and one in scientific publications, with reference to the players how found the solutions, if such exist.

Architecture

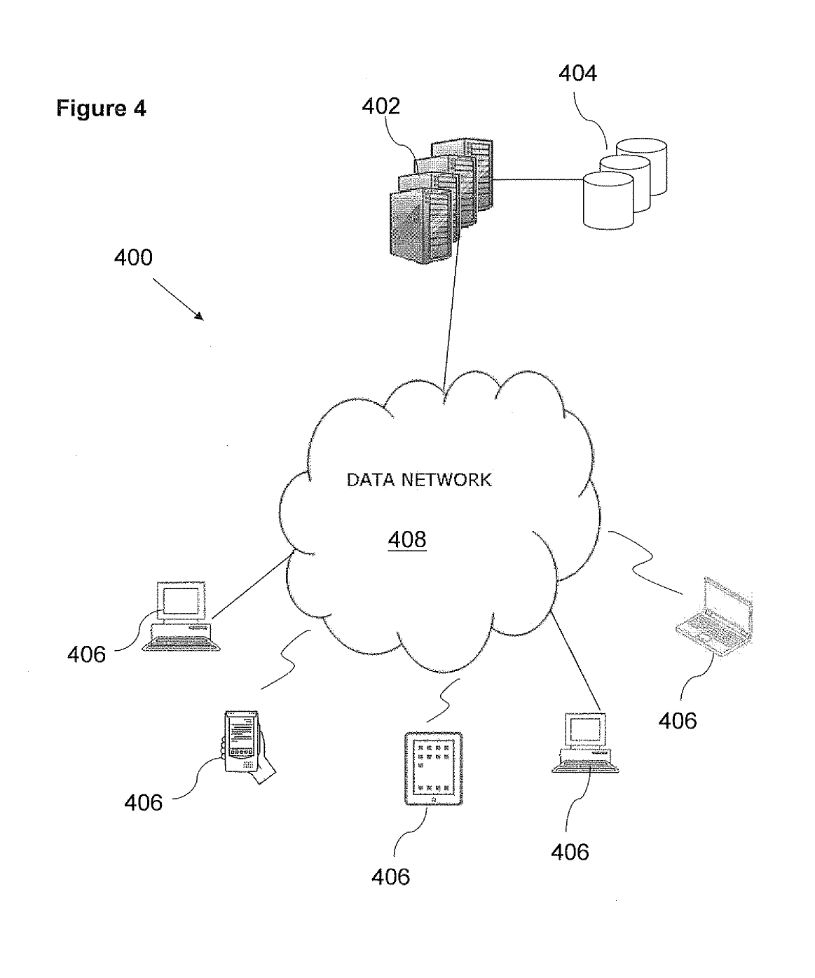

FIG. 4 is a basic depiction of the innovative system. Gaming platform 400 includes a server or plurality of servers 402. It is understood that many different configurations of servers can be used and that the described configuration is merely an exemplary embodiment of the platform. Servers 402 may be a plurality of interconnected collocated servers, or a distributed server network interconnected via a data network, such as but not limited to, the Internet. Storage mechanisms 404 may be integrated or externally located as necessary. Servers 402 provide the innovative gaming platform accessible by end users 406. The system facilitates either a single-player gaming experience or a multiple-player interactive experience. End users 406 connect to the system servers over a data network 408, such as, but not limited to, the Internet. The system provides an interactive multiplayer gaming environment using methods known in the art, such as, but not limited to, those discussed previously.

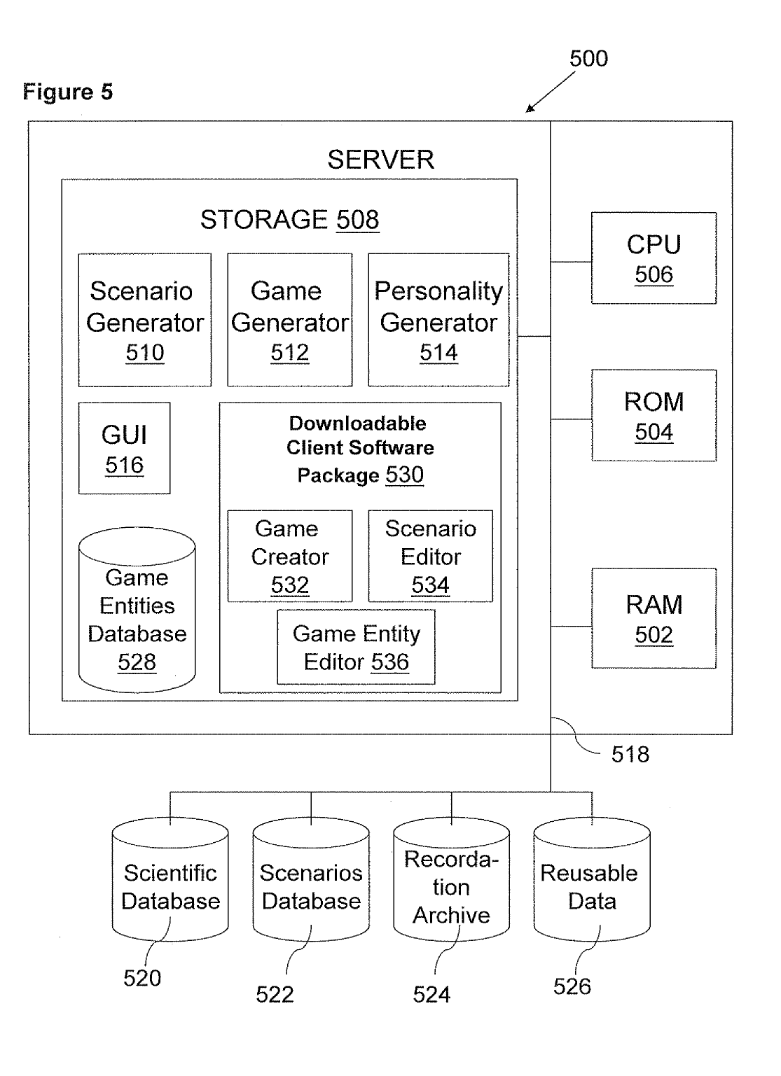

FIG. 5 is a schematic block-drawing of a preferred embodiment of the hardware/software architecture of the innovative gaming platform. Server 500 includes a RAM 502, a ROM 504, a CPU 506 (or any other processor), storage unit 508 and a bus 518 connecting all the components to each other. It is clear that the high-level block diagram is only a partial representation of a server. Furthermore, each of the components depicted within server 500 are not intended to be limiting but rather representative of an exemplary embodiment. Some or all of the components depicted in storage unit 508 may alternatively reside in one or more additional servers which may or may not be collocated. Software components stored in storage unit 508 include but are in no way limited to a Scenario Generator 510 software module, a Game Generator 512 module, a Personality Generator 514 module, a Downloadable Client Software Package 530, a Graphic User Interface (GUI) 516 and an Objects/Game Entities Database 528.

Game generator 512 creates the ‘universe’ and game environment. The generator resides on server 500 and can either generate games according to predefined parameters (default games) or, innovatively, according to instructions sent by a user. A user downloads Downloadable Client Software Package 530 which includes at least a Game Creator software module 532 and a Scenario Editor software module 534. (A wider discussion of the client side software package can be found below in the Architecture section.) Using Game Creator 532, a user sends instructions to server to 500 for creating games based on the selection/s of Game Entities made in the first stage of the game. Scenario Generator 510 generates game scenarios, problems or challenges for each of the unique games.

The Scenarios can be generated by users (see section below on “Authoring”) using Client Software Package 530, or the scenarios can be generated randomly (or semi-randomly or pseudo-randomly) by the system programming logic. User-generated scenarios are generated by Scenario Generator 510 in accordance with instructions received from client-side software 530 (e.g. a Scenario Editor discussed below) which can be downloaded from the Server 500. Alternatively or additionally, a user can access Scenario Generator 510 directly over a Data network 408 and create or edit scenarios using a Scenario Editing software tool. User-defined scenarios can be generated using either of the aforementioned methods and existing scenarios can likewise be altered or deleted (i.e. archived but removed from the immediate game)—whether the scenarios are user-defined or randomly generated.

Game Entities Database 528 includes Modules 102 discussed above (including BSOMs SSOMs, Elements etc.). In some embodiments, Modules 102 may be predefined within the system, imported from external knowledge bases (e.g. Wikipedia™ articles which are used as references for defining parameters of the entities) or user defined (e.g. a hypothetical object, a newly discovered object, a fictitious object). Furthermore, existing Game Entities (Modules, structure, sub-structure, elements, Time etc.) may be edited by redefining various parameters and characteristics of the entity. Embodiments of the platform which allow creating and/or editing of game entities include a Game Entity Editor 536 in the Client Software Package 530.

Personality Generator 514 enhances or otherwise defines parameters of a game so as to be more conforming to a particular personality type (e.g. a type selected according to the MBTI classification system or any other personality classification system). GUI 516 includes standard screens for the initial stage of the game as well as a generating unit for generating 2-D or 3-D graphical environments for each of the unique games. Objects and environments can be selected by the user of GUI 516 from Objects Database 528 which is continually updated and added to (which is true for all the databases and software modules of the system) as the games progress and evolve.

Computer readable instructions, i.e. program code, of the aforementioned software modules, is stored on a storage medium such as a hard drive, a flash drive, CD/DVD, or other non-volatile storage medium, known in the art and generally depicted as storage unit 508. The instructions are loaded into RAM 502 and executed by CPU 506. As mentioned previously regarding other computing components, CPU 506 is an exemplary representation of a processor or a plurality of processors which may or may not be collocated, and which may or may not work in parallel or otherwise synchronous manner. A plurality of databases is depicted, exemplarily external to Server 500. Potentially, the databases may be stored on a single storage medium or a plurality of storage medium either integral to Server 500 or external thereto (as depicted). Furthermore, the storage mediums may or may not be collocated with server 500 or with each other for that matter. Still furthermore, even a single database may be stored on more than one storage medium, which once again may or may not be collocated.

Exemplary databases include at least: a Scientific Database 520 for storing scientific knowledge pertaining to the structures, substructures and elements of the gaming platform; a Scenarios Database 522 for storing a plurality of predefined scenarios and/or scenarios elements which can be combined (randomly or otherwise) to produce new scenarios; a Recordation Archive 524 for recording all or substantially all information pertaining to collaborations, solutions, hypotheses etc.; and a Reusable Data database 526 for storing scenarios, solutions, problems and other data generated during the course of the games which can be reused in other instances of the gaming platform. Data stored in the aforementioned databases/archives may be accessed for observation and research purposes as discussed below.

### DETAILED ASPECTS OF GAME INFRASTRUCTURE

Multi-user games, as well as platforms to support the creation of such games, have been around for more than a decade, and are available from multiple sources. However, such platforms are usually commercial and complex to use, leading many companies develop an in-house solution.

Whatever the solution used, multi-user gaming usually focuses on the interaction and relay of information between players. Other game content aspects such as persistency and game architecture are left for each game developer, adding more time and cost to the production.

The immediate invention provides a new platform that allows for easy development, hosting and delivery of game content.

System Functionality and User Roles

The immediate system supports three distinct execution modes—Authoring, Simulation Playback, and Interactive Game Play.

Authoring

Subject matter experts, such as University Professors, create and modify scenes. Each scene belongs to a specific game hierarchy level, such as ‘Planetary System’ or ‘Battlefield’. The author can create, within the predefined rules and given tools, the settings such as planets or shorelines, the characters such as soldiers, the rules such as gravity and attack goal, the timeline and other aspects. Within the timeline authors can define key points/milestones and the state of each character at that time.

Simulation Playback

Simulation playback is used by Authors (above) to check their content. Viewers/Researchers/Observers, such as University Students, are tasked with learning each scene with respect to the physical, historical and/or other context. Players (see below) serve as a control group or Beta testers in preparation for the actual gameplay.

Interactive Players

Users can actually participate in the scenes interactively, individually or in groups, affecting the outcome and/or gaining points for goals attained. The gameplay is still restricted to whatever goals the Author has set, such as gaining points only for killing enemy characters or ending the game if planets collide.

User Relationships

WoC or CB can be played alone or with a group. While one person takes the role of a player, and the others are Observers, involved in the discussion of the player's actions.

Alternatively, the game can be played as a multiplayer game, as players have the possibility of communicating with each other, and each player can receive a list of personal objectives and goals. The objectives and goals of different players may be coincide with the goals and objectives of other players (then the players will be able to work together), or the goals may be opposing, in which case the players will work against each other.

The game is also used as a teaching tool, not only for pleasure. For example, if a professor, or other specialist, creates a scenario with a set of goals for a student or a player, according to which the student will have to modify the simulation/scenario one way or another in order to achieve a specified goal, then the game serves as a teaching tool.

To this end, at each of the possible phases of the game (creating universes, galaxies, star systems, the emergence of life, war, etc.) the system provides a software tool such as a “Scenario Creator” or “Scenario Editor” 534 for tailor-making scenarios within a game.

The scenarios used for the game can be two-dimensional or three-dimensional. It is also necessary that the players are able to start playing from the point that they are interested in. To this end, students of physics or biology, for example, are interested in stages of, or scenarios about, a galaxy/universe/solar systems, or the appearance of life, while others might be interested in, for example, only the theme of war. Each scenario can be access directly within the defined parameters of the game.

High-Level Design

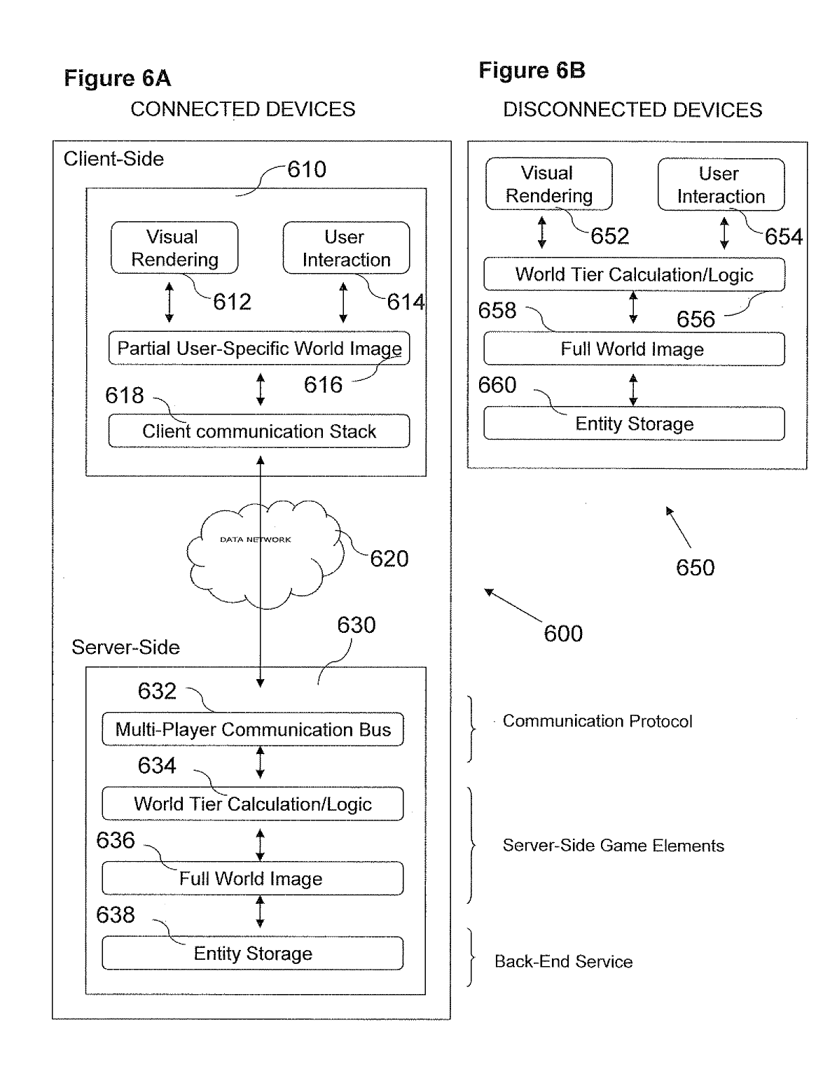

FIG. 6A is an exemplary high-level design for connected devices and FIG. 6B is an exemplary high-level design for disconnected devices for implementation of the immediate invention. Referring now to both FIG. 6A and FIG. 6B, the depicted design is based on a standard model, used by games, military and civilian simulation systems, command-and-control systems, and the like. The design models the virtual or real world in terms of ‘elements’, each with visualization, properties and interaction with other elements. For example, a planet may have a mass, material composition, velocity and direction. Progression of the planet over time is affected, at least, by the aforementioned properties as well as the properties of other elements, leading to the eventual collision of the planet with another planet.

Each virtual world is stored in a persistent repository such as relational or big data database, cached in the processing server, and partially cached in each viewer software as needed. The processing server runs the simulation or game timeline, applying the results of each time progression (a virtual world time increment or “clock-tick”), and relaying any changes in the properties of the various elements to the connected users. User actions are sent to the processing server where they are applied on the affected element at the next processing cycle.

Client-Side 610 contains all the software components and data residing and executing on a user device.

Server-Side 630 contains all the software components and data residing and executing on one or more servers, physical, virtual, and optionally part of a cloud, which services user requests—usually in a multi-player scenario.

Connected Devices 600 is a setup where one or more user devices access central Server-Side elements from their Client-Side elements.

Disconnected Devices 650 is a setup where an independent user device contain all the components of both Client- and Server-Side, thus allowing users to experience the specific world and its gameplay even without being connected to the network where the required Server-Side elements are available.

Visual Rendering 612/652 are software components displaying game elements in the specific visual representation, graphic style and rendering technique (such as 2D or 3D) relevant to the specific world. Note that a specific world may be rendered in different manners, such as for beginners vs. advanced users, large vs. small form-factor (such as desktops vs. smartphones), low-level vs. common-denominator technology (such as specific Sony PlayStation version vs. generic web-based. HTML version), etc.

User Interaction 614/654 are software components responding to user activity in the context of the world, its rules, the specific player capabilities and situation in the gameplay. Users may employ keyboard, mouse, touch panels, body and hand detection (such as Kinect), speech recognition, etc. Preferably, the system employs existing devices and technologies currently available and most commonly found on user devices, such as touch gestures on an iPad and keyboard and mouse on a Windows desktop. Less preferably, the system provides game-specific devices such as uniquly developed user-interaction technologies.

Partial User-Specific World Image 616 contains only those game entities relevant for the specific player, in order to minimize memory footprint and update traffic.

Client Communication Stack 618 is a software component that submits user actions from the device to the multi-player servers, and receives world entity changes notifications. For example, if the user initiates a kick movement at an enemy, the command is sent to the server, and if the enemy sustained damage, then the damage information is sent to all the players currently aware of that enemy game element. Communication can be carried on top of HTTP connections, as most other relevant communication protocols such as sockets, TCP/UDP, WCF, network pipes and queuing services such as IBM MQ or Microsoft MSMQ are incompatible with public internet connectivity. However, advanced over-the-internet techniques such as “long calls” or upcoming modern HTML5 alternatives such as WebSockets may also or alternatively be used.

Multi-Player Communication Bus 632 is a software component capable of quickly accepting user submissions (such as game element moves) and—with a greater degree of complexity—submit game element changes back to users. One challenge is Internet servers being unable to submit information to clients. A second challenge is providing service to a large number of concurrent users, but probably not through stateless request-response, which reduces the overall number of requests handled but more importantly increases the time it takes to process user notifications and submit notifications to users. Therefore, relevant techniques such as connectionless sockets and asynchronous communication are preferably used, similar to technology that audio and video streaming servers currently employ.

World Tier Calculation/Logic 634/656 are a set of scripts, rules, logic code and similar software components which respond to time and user events in a manner compatible with “rules” set for each specific world. The specific logic of each world is further supported by generic shared components performing physical calculations, basic validations such as element collision detection, common game element scheme and manipulation such as life/energy/ammunition/inventory and similar facilities.

Full World Image 636/658 contains the entire set of game entities (see relevant section) and corresponding properties, and is employed for both independent disconnected device gameplay as well as in a multi-user server.

Entity Storage 638/660 maintains the game elements state and relations for each world respectively. For example, in a planetary system a planet may list a mass and material composition, as well as the main star the planet orbits.

### Example

An exemplary pseudo-code for the viewer software and processing server is presented below for a tank battle:

```
-- viewer software
on server_notification
      for each notification
            if element is tank then
                  set tank position to notification position
                  set tank direction to notification direction
                  if notification state is exploded
                        play tank explosion animation
on key_press
      if key is left arrow then
            send rotate tank to left to server
      if key is right arrow then
            send rotate tank to right to server
      if key is up arrow then
            send accelerate tank to server
-- processing server
on client_request
      if request is rotate tank to left then
            set tank angle −5
      if request is rotate tank to right then
            set tank angle +5
      if request is accelerate tank
            set tank speed +10
      for each tank
            if tank collides with any other tank
                  set tank state to explode
      for each tank
            if tank state changed
                  send changed properties to all users
Example end.
```

Deployment Models

The system is designed to scale for any number of scenes and users, by scaling out to multiple servers. Each server is similar to a web hosting facility, containing a specific set of scenes and all-user access, including interactive gameplay, for the stored scenes. In a ease where the user-load for a specific scene grows beyond capacity, the scene may be migrated to a separate server, or even a dedicated server or group of servers for the specific scene. The current design allows any number of users to access a specific scene given enough servers, but only a limited number (projected: 10,000) may interact together in any one group.

Due to the separation of virtual world management and presentation tiers, users may access the scenes from different devices from desktop PCs to smartphones, as long as the device is supported by a system viewer software component. Different types of devices may participate in the same gameplay group.

For security and business concern reasons, the design supports both cloud and traditional web hosting models: the software can be deployed on either model, and the viewer software component acts as a web service for whichever model is deployed.

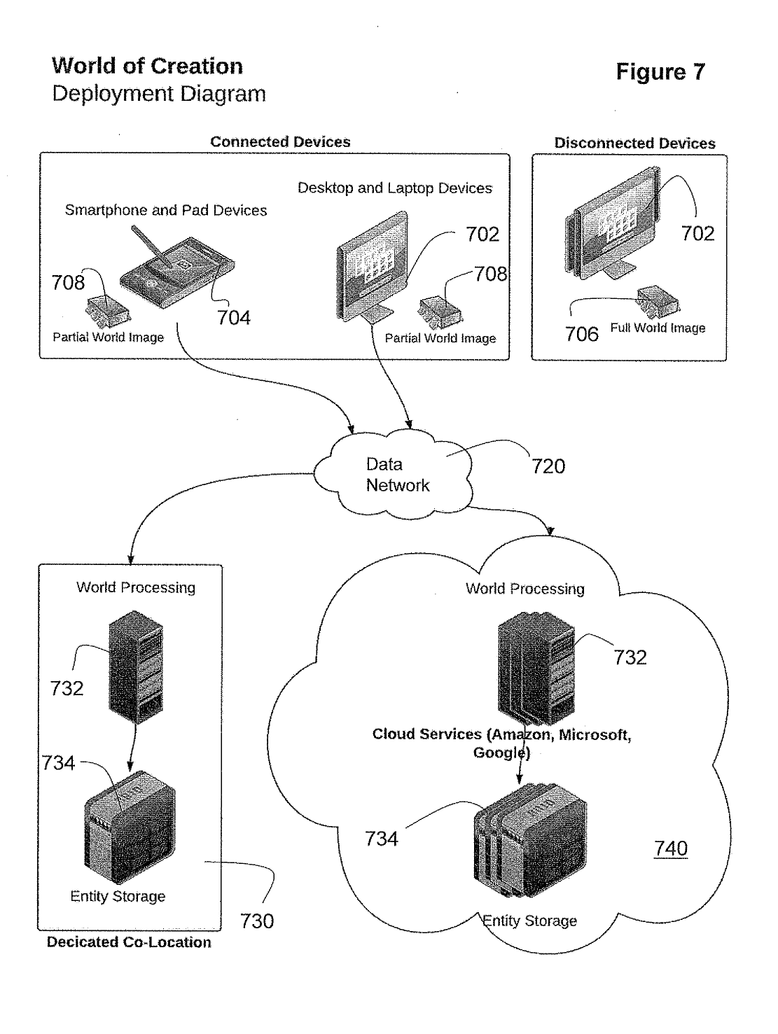

FIG. 7 is an exemplary high-level deployment diagram for the innovative gaming platform. Referring now to FIG. 7:

Desktop and Laptop devices 702 include Windows and Mac OS/X, and may optionally include game consoles such as Sony PlayStation, Nintendo Wii, and Microsoft XBox, as well as upcoming web-capable devices—mostly TVs.

Smartphone and IPad devices 704 include iOS and Android devices, with future Windows 8 Mobile devices. Support for older or declining platforms such as Symbian and BlackBerry is possible but not recommended.

Full World Image 706 contains the entire set of game entities (see relevant section) and their properties, and is used for an independent disconnected device 702 gameplay and in a multi-user server.

Partial World Image 708 contains only those game entities relevant for the specific player, in order to minimize memory footprint and update traffic.

Data Network 720 includes any network setup, and could be deployed in a facility such as university, school, hotel or hospital for indoor multi-player gaming. With a sufficient powerful setup and available bandwidth, the system can facilitate worldwide multi-player gaming over the Internet.

Dedicated Co-Location 730 is provided by commercial companies such as

RackSpace and iWeb, which rent clients such as WoC space, high-bandwidth high-availability multiple connections to the Internet backbone, high-availability facilities through UPS, fire and other hazard management, and IT support personnel.

Cloud Services 740 such as Microsoft Azure and Amazon AWS provide virtual managed computing facilities including processing, connectivity, database and storage, which may begin at lower prices but allow, with the correct product architecture design, to grow almost indefinitely to any scale required.

World Processing 732 are a set of processing nodes (virtual services, cores, server hosts) that access and manipulate a Full World Image (above) based on game clock events, user actions, and the rules (physical and otherwise) and game logic employed for the specific world.

Entity Storage 734 are a set of storage units, using relational databases, big-data (“NoSQL”) storage or any alternative, storing the world game entities and their storage in a persistent way to prevent the entire world disappearing in case of hardware or software difficulties, such as a power failure or system crash.

Implementation Technology

All multi-player game content employ the classic two tiers—client and server. Additionally, the WoC platform provide various support tiers including back-end services such as data storage, utilities such physics rules, and communication services.

Similar setup (besides minor rewrite for server-side game components) supports a single-user independent game version.

Server-Side is based on co-located hosted servers or cloud services, initially Microsoft technologies.

Client-Side can use two models:
Standard options for the target client platform's technology, such as C++/DirectX for high-end Windows content, Objective C for high-end iOS content, etc.
The preferred method is DHTML/JavaScript for platform-agnostic game content.

Individual platform elements are implemented using the following technologies:

Back-End Infrastructure elements such as databases and web servers are initially based on the Microsoft stack (see Server-Side above). Once the platform is migrate to cloud services, the preferred option will use Microsoft Azure and maintain the same implementation; if conditions require (such as investment or business reason) the implementation will migrate to the cloud services of choice, such as Amazon or Google.

Server-Side Services such as user management and physics services are implemented using the Microsoft stack (see Server-Side above). A future migration to alternative technology is supported by platform-agnostic communication protocols (see below).

Server-Side Game elements such as entity scheme and interaction are implemented using the Microsoft stack (see Server-Side above). A future migration to alternative technology is supported through a rewrite of these specific elements (but not of any other).

Client-Side Game elements such as partial world image entity states and interaction are implemented using platform-agnostic (the preferred method) or platform-specific technologies (see Client-Side above).

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A computerized system comprising:
a processor;
at least one database of game entities; and
a computer-readable non-transient memory in communication with the processor, the memory storing instructions for providing a gaming platform, the instructions including:
(a) program code for a server-side system including:
(i) a game generator program for generating games using at least one of said game entities,
(b) program code for a downloadable client side system including:
(i) a game selector program for selecting at least one game entity for game generation by said game generator program on said server-side system.

2. The computerized system of claim 1, wherein said server side system further includes:
(ii) a Scenario Generator program for generating scenarios for a said generated game.

3. The computerized system of claim 2, wherein said Scenario Generator generates scenarios selected from the group comprising: user-defined scenarios, random scenarios, semi-random scenarios and pseudo-random scenarios.

4. The computerized system of claim 3, wherein said downloadable client side system further includes:
(ii) a Scenario Editor program, for providing editing instructions to said Scenario Generator for editing said scenarios.

5. The computerized system of claim 4, wherein said editing instructions include instructions to effect functions selected from the group including: creating said user-defined scenario for a said generated game, deleting a said scenario from a generated game and altering a said scenario.

6. The computerized system of claim 1, wherein said program code for said server-side system further includes:
(ii) a Personality Generator program, for defining parameters of a said generated game in accordance with a set of predefined Personality Type rules.

7. The computerized system of claim 6, wherein said predefined Personality Type rules are dictated by a personality classification system.

8. The computerized system of claim 1, wherein said game entities are selected from the group comprising: predefined game entities, game entities imported from an external source and user-defined game entities.

9. The computerized system of claim 1, wherein each of said game entities includes:
(i) a structure, defined by parameters of said structure;
(ii) at least one sub-structure, associated with said structure; and
(iii) a plurality of elements, populating said at least one sub-structure.

10. The computerized system of claim 1, wherein said program code for said downloadable client side system further includes:
(ii) a Game Entity Editor program, for editing said game entities.

11. The computerized system of claim 10, wherein said editing of said game entities includes effecting functions selected from the group including: altering parameters of a said gaming entity and creating a new said gaming entity.

12. A computing system for a gaming platform, comprising:
(a) at least one networked server;
(b) a client computer-readable instruction set, associate with said at least one networked server and downloadable by a user, said instruction set for interacting with said at least one network server; and
(c) at least one entity storage unit, associated with said at least one networked server, for storing a database of game entities of the gaming platform, said game entities for generating games on the gaming platform.

13. A method for facilitating crowd sourcing using a gaming platform, the method comprising the steps:
(a) providing a server, including:
(i) a database of game entities,
(ii) a Scenario Generator module for generating scenarios using game entities selected from said database, and
(iii) downloadable Scenario Editor module, for electively selecting at least one game entity from said database and instructing said scenario generator to generate a said scenario using said at least one selected game entity; and
(b) receiving scenario generating instructions from an instance of said Scenario Editor module that has been downloaded to a client, for said Scenario Generator module to generate a said scenario.

14. The method of claim 13, further comprising the steps of:
(c) generating a said scenario according to said received scenario generating instructions;
(d) publishing said generated scenario to a plurality of Players over a Data Network;
(e) receiving interactions from said Players over said Data Network; and
(f) sending server responses, responsive to said Player interactions, over said Data Network.

15. The method of claim 14, further comprising the step of:
(g) providing observation tools, for observing said interaction of said players with said generated scenario.

16. The method of claim 15, wherein said observing includes activities selected from the group including: recording player interaction sequences in a recordation archive, recording player solutions to said generated scenarios in said recordation archive, analyzing player interaction sequences, analyzing player solutions to said generated scenarios.

17. The method of claim 14, wherein said Data Network is a network selected from the group including: an internetwork of networks, an intranet.

18. The method of claim 15, further comprising the step of:
(h) providing a publication tool for publishing a portion of said observations.
